(19) United States
(12) Patent Application Publication
(10) Pub. No.: US 2011/0047006 A1
(43) Pub. Date: Feb. 24, 2011

(54) SYSTEMS, METHODS, AND MEDIA FOR RATING WEBSITES FOR SAFE ADVERTISING

(76) Inventors: Joshua M. Attenberg, Roxbury, CT (US); Foster J. Provost, New York, NY (US)

Correspondence Address: Byrne Poh LLP, 11 Broadway, Ste 865, New York, NY, 10004, US

(21) Appl. No.: 12/859,763

(22) Filed: Aug. 19, 2010

Related U.S. Application Data
(60) Provisional application No. 61/235,926, filed on Aug. 21, 2009.
(60) Provisional application No. 61/350,393, filed on Jun. 1, 2010.

(51) Int. Cl. G06Q 30/00

(52) U.S. Cl. 705/10

(57) ABSTRACT

Systems, methods, and media for rating websites for safe advertising are provided. In accordance with some embodiments of the disclosed subject matter, the method comprises: receiving a uniform resource locator corresponding to a webpage; selecting a plurality of evidentiary sources for obtaining evidence relating to the uniform resource locator, wherein each piece of evidence corresponds to one of the plurality of evidentiary sources; converting each piece of evidence obtained from the plurality of evidentiary sources into a plurality of instances that describe the webpage; applying the plurality of instances to a plurality of rating models, wherein each of the plurality of rating models generates an ordinomial and wherein the ordinomial encodes a probability of membership in one or more severity classes of a category; combining the ordinomial from each of the plurality of rating models into a combined ordinomial probability estimate; and generating a rating for the webpage based at least in part on the combined ordinomial probability estimate, wherein the rating identifies whether the webpage is likely to contain objectionable content of the category.

### CROSS-REFERENCE TO RELATED APPLICATIONS

This application claims the benefit of U.S. Provisional Patent Application No. 61/235,926, filed Aug. 21, 2009, which is hereby incorporated by reference herein in its entirety.

This application is also related to U.S. Provisional Patent Application No. 61/350,393, filed Jun. 1, 2010, which is hereby incorporated by reference herein in its entirety.

### FIELD OF THE INVENTION

The disclosed subject matter generally relates to systems, methods, and media for rating websites for safe advertising. More particularly, the disclosed subject matter relates to generating probabilistic scores and ratings for web pages, websites, and other content of interest to advertisers.

### BACKGROUND OF THE INVENTION

Brands are carefully crafted and incorporate a firm's image as well as a promise to the firm's stakeholders. Unfortunately, in the current online environment, advertising networks may juxtapose advertisements that represent such brands with undesirable content due to the opacity of the ad-placement process and possibly to a misalignment of incentives in the ad-serving ecosystem. Currently, neither the ad network nor the brand can efficiently recognize whether a website contains or has a tendency to contain questionable content.

Online advertisers use tools that provide information about websites or publishers and the viewers of such websites to facilitate more effective planning and management of online advertising by advertisers. Moreover, online advertisers continually desire increased control over the web pages on which their advertisements and brand messages appear. For example, particular online advertisers want to control the risk that their advertisements and brand messages appear on pages or sites that contain objectionable content (e.g., pornography or adult content, hate speech, bombs, guns, ammunition, alcohol, offensive language, tobacco, spyware, malicious code, illegal drugs, music downloading, particular types of entertainment, illegality, obscenity, etc.). In another example, particular online advertisers want to increase the probability that their content appears on specific sorts of sites (e.g., websites containing news-related information, websites containing entertainment-related information, etc.). However, current advertising tools merely provide a probability estimate that a web site contains a certain sort of content.

There is therefore a need in the art for approaches for applying scores and ratings to web pages, web sites, and content for safe and effective online advertising. Accordingly, it is desirable to provide methods, systems, and media that overcome these and other deficiencies of the prior art.

For example, the disclosed subject matter provides advertisers, agencies, advertisement networks, advertisement exchanges, and publishers with a measurement of content quality and brand appropriateness. In another example, using rating models and one or more sources of evidence, the disclosed subject matter allows brand managers and advertisers to advertise with confidence, advertisement networks to improve performance of their inventory, and publishers to more effectively market their properties.

### SUMMARY OF THE INVENTION

In accordance with various embodiments, mechanisms for rating websites for safe advertising are provided.

In accordance with some embodiments of the disclosed subject matter, a rating application (sometimes referred to herein as “the application”) is provided. The rating application, among other things, selects or receives one or more webpages or any other suitable content, receives or collects evidence relating to the webpage, and generates a risk rating that accounts for the inclusion of objectionable content. The risk rating can, in some embodiments, represent the probability that a page or a site contains or will contain objectionable content, the degree of objectionability of the content, and/or any suitable combination thereof.

Systems, methods, and media for rating websites for safe advertising are provided. In accordance with some embodiments of the disclosed subject matter, the method comprises: receiving a uniform resource locator corresponding to a webpage; selecting a plurality of evidentiary sources for obtaining evidence relating to the uniform resource locator, wherein each piece of evidence corresponds to one of the plurality of evidentiary sources; converting each piece of evidence obtained from the plurality of evidentiary sources into a plurality of instances that describe the webpage; applying the plurality of instances to a plurality of rating models, wherein each of the plurality of rating models generates an ordinomial and wherein the ordinomial encodes a probability of membership in one or more severity classes of a category; combining the ordinomial from each of the plurality of rating models into a combined ordinomial probability estimate; and generating a rating for the webpage based at least in part on the combined ordinomial probability estimate, wherein the rating identifies whether the webpage is likely to contain objectionable content of the category.

In some embodiments, the plurality of evidentiary sources are selected based at least in part on a budget parameter.

In some embodiments, the method further comprises determining an optimized subset of evidentiary sources based at least in part on the plurality of evidentiary sources, the uniform resource locator, and the budget parameter.

In some embodiments, the method further comprises merging each piece of evidence obtained from the plurality of evidentiary sources into a page object associated with the uniform resource locator.

In some embodiments, the method further comprises receiving feedback relating to the evidence obtained from the plurality of evidentiary sources, wherein additional evidence is collected in response to receiving the feedback and wherein a revised page objected is created.

In some embodiments, each instance maps facets from the obtained evidence with a particular feature.

In some embodiments, the plurality of rating models are modular such that a rating model can be inserted and removed from the plurality of rating models applied to the plurality of instances.

In some embodiments, the category includes at least one of: adult content, guns, bombs, ammunition, alcohol, drugs, tobacco, offensive language, hate speech, obscenities, gaming, gambling, entertainment, spyware, malicious code, and illegal content.

In some embodiments, the method further comprises: generating an ordinomial distribution that includes each ordinomial for the one or more severity classes; receiving a confidence parameter; and removing at least one of the one or more severity classes based at least in part on the confidence parameter.

In some embodiments, the method further comprises applying weights to each piece of evidence obtained from the plurality of evidentiary sources. In some embodiments, the method further comprises applying weights to each of the plurality of rating models.

In some embodiments, the method further comprises training at least one of the plurality of rating models with labeling instances.

In some embodiments, the method further comprises: using the plurality of rating models to assign a utility to unlabeled instances; and transmitting unlabeled instances having an assigned utility that is greater than a predetermined value to an oracle for labeling.

In some embodiments, the method further comprises: receiving a plurality of uniform resource locators associated with a plurality of webpages; and generating a priority list of the plurality of uniform resource locators, wherein the priority list is generated based on one of: frequency of each uniform resource locator in an advertisement stream, frequency of changes on the webpage associated with each uniform resource locator, page popularity of each uniform resource locator, and a utility estimate of each uniform resource locator.

In some embodiments, a system for rating webpages for safe advertising is provided, the system comprising a processor that: receives a uniform resource locator corresponding to a webpage; selects a plurality of evidentiary sources for obtaining evidence relating to the uniform resource locator, wherein each piece of evidence corresponds to one of the plurality of evidentiary sources; converts each piece of evidence obtained from the plurality of evidentiary sources into a plurality of instances that describe the webpage; applies the plurality of instances to a plurality of rating models, wherein each of the plurality of rating models generates an ordinomial and wherein the ordinomial encodes a probability of membership in one or more severity classes of a category; combines the ordinomial from each of the plurality of rating models into a combined ordinomial probability estimate; and generates a rating for the webpage based at least in part on the combined ordinomial probability estimate, wherein the rating identifies whether the webpage is likely to contain objectionable content of the category.

In some embodiments, a non-transitory computer-readable medium containing computer-executable instructions that, when executed by a processor, cause the processor to perform a method for rating webpages for safe advertising, the method comprising: receiving a uniform resource locator corresponding to a webpage; selecting a plurality of evidentiary sources for obtaining evidence relating to the uniform resource locator, wherein each piece of evidence corresponds to one of the plurality of evidentiary sources; converting each piece of evidence obtained from the plurality of evidentiary sources into a plurality of instances that describe the webpage; applying the plurality of instances to a plurality of rating models, wherein each of the plurality of rating models generates an ordinomial and wherein the ordinomial encodes a probability of membership in one or more severity classes of a category; combining the ordinomial from each of the plurality of rating models into a combined ordinomial probability estimate; and generating a rating for the webpage based at least in part on the combined ordinomial probability estimate, wherein the rating identifies whether the webpage is likely to contain objectionable content of the category.

### BRIEF DESCRIPTION OF THE DRAWINGS

Various objects, features, and advantages of the disclosed subject matter can be more fully appreciated with reference to the following detailed description of the invention when considered in connection with the following drawing, in which like reference numerals identify like elements.

FIG. 1 is a diagram of an example of a process for determining the probability of membership in a severity group for a category of objectionable content in accordance with some embodiments of the disclosed subject matter.

FIG. 2 is a diagram of an example of a process for generating one or more ratings for a webpage in accordance with some embodiments of the disclosed subject matter.

FIG. 3 is a diagram of a graph showing the selection of an appropriate bin (bᵢ) in an ordinomial given a confidence parameter (β) in accordance with some embodiments of the disclosed subject matter.

FIG. 4 is a diagram of an illustrative rating scale in accordance with some embodiments of the disclosed subject matter.

FIG. 5 is a diagram of an illustrative URL chooser component and an illustrative evidence collection component in accordance with some embodiments of the disclosed subject matter.

FIG. 6 is a diagram of an illustrative instancifier that maps information in one or more pieces of evidence in a single instance in accordance with some embodiments of the disclosed subject matter.

FIG. 7 is a diagram of an illustrative instancifier that maps facets contained in the input evidence into one or more feature/value pairs in accordance with some embodiments of the disclosed subject matter.

FIG. 8 is a diagram of an example of predictive modeling in accordance with some embodiments of the disclosed subject matter.

FIG. 9 is a diagram of a modular classification component that includes pluggable models in accordance with some embodiments of the disclosed subject matter.

FIG. 10 is a diagram of an ensemble that includes a final combining model in accordance with some embodiments of the disclosed subject matter.

FIG. 11A is a diagram of an illustrative batch training process for training a rating model in accordance with some embodiments of the disclosed subject matter.

FIG. 11B is a diagram of an illustrative active learning process for training a rating model in accordance with some embodiments of the disclosed subject matter.

FIG. 11C is a diagram of an illustrative online active learning process for training a rating model in accordance with some embodiments of the disclosed subject matter.

FIG. 12 is a diagram of an illustrative active feature value acquisition process in accordance with some embodiments of the disclosed subject matter.

FIG. 13 is a diagram of an illustrative system on which a rating application can be implemented in accordance with some embodiments of the disclosed subject matter.

FIG. 14 is a diagram of an illustrative system architecture in accordance with some embodiments of the disclosed subject matter.

FIG. 15 is a diagram of an illustrative user computer and server as provided, for example, in FIG. 13 in accordance with some embodiments of the disclosed subject matter.

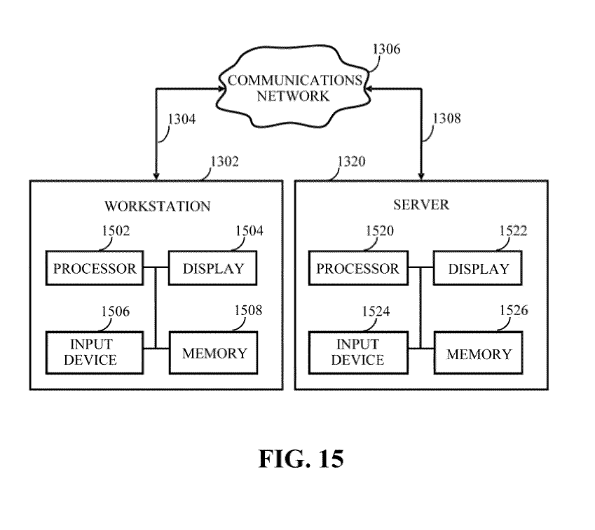

### DETAILED DESCRIPTION OF THE INVENTION

In accordance with some embodiments of the disclosed subject matter, a rating application is provided. The rating application, among other things, selects or receives one or more webpages or any other suitable content, receives or collects evidence relating to the webpage, and generates a risk rating that accounts for the inclusion of objectionable content. The risk rating can, in some embodiments, represent the probability that a page or a site contains or will contain objectionable content, the degree of objectionability of the content, and/or any suitable combination thereof.

Generally speaking, the disclosed subject matter allows advertisers, ad networks, publishers, site managers, and other entities to make risk-controlled decisions based at least in part on risk associated with a given webpage, website, or any other suitable content (generally referred to herein as a “webpage” or “page”). For example, these entities can decide whether to place an advertisement on a page upon determining with a high confidence that such a page does not contain objectionable content. In another example, these entities can determine which pages in their current ad network traffic are assessed to have the highest risk of including objectionable content.

It should be noted that there can be several categories of objectionable content that may be of interest. For example, these categories can include content that relates to guns, bombs, and/or ammunition (e.g., sites that describe or provide information on weapons including guns, rifles, bombs, and ammunition, sites that display and/or discuss how to obtain weapons, manufacture of weapons, trading of weapons (whether legal or illegal), sites which describes or offer for sale weapons including guns, ammunition, and/or firearm accessories, etc.). In another example, these categories can include content relating to alcohol (e.g., sites that provide information relating to alcohol, sites that provide recipes for mixing drinks, sites that provide reviews and locations for bars, etc.), drugs (e.g., sites that provide instructions for or information about obtaining, manufacturing, or using illegal drugs), and/or tobacco (e.g., sites that provide information relating to smoking, cigarettes, chewing tobacco, pipes, etc.). In yet another example, these categories can include offensive language (e.g., sites that contain swear words, profanity, hard language, inappropriate phrases and/or expressions), hate speech (e.g., sites that advocate hostility or aggression towards individuals or groups on the basis of race, religion, gender, nationality, or ethnic origin, sites that denigrate others or justifies inequality, sites that purport to use scientific or other approaches to justify aggression, hostility, or denigration), and/or obscenities (e.g., sites that display graphic violence, the infliction of pain, gross violence, and/or other types of excessive violence). In another example, these categories can include adult content (e.g., sites that contain nudity, sex, use of sexual language, sexual references, sexual images, and/or sexual themes). In another example, these categories can include spyware or malicious code (e.g., sites that provide instructions to practice illegal or unauthorized acts of computer crime using technology or computer programming skills, sites that contain malicious code, etc.) or other illegal content (e.g., sites that provide instructions for threatening or violating the security of property or the privacy of others, such as theft-related sites, locking picking and burglary-related sites, fraud-related sites).

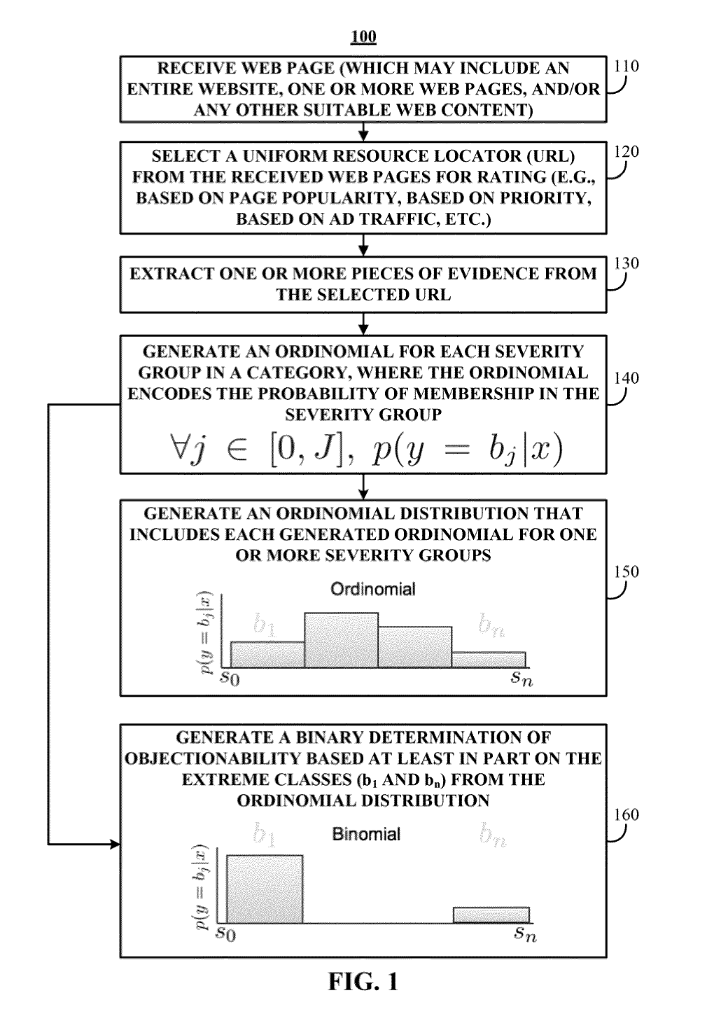

FIG. 1 is a diagram showing an example of a process for determining the probability of membership in a severity group for one or more category of objectionable content in accordance with some embodiments of the disclosed subject matter. As shown in FIG. 1, process 100 begins by receiving or reviewing content on a webpage, website, or any other suitable content (generally referred to herein as a “webpage” or “page”) at 110. For example, in some embodiments, a rating application can receive multiple requests to rate a group of webpages or websites. In another example, a rating application can receive, from an advertiser, a list of websites that the advertiser is interested in placing an advertisement provided that each of these websites does not contain or does not have a high likelihood of containing objectionable content.

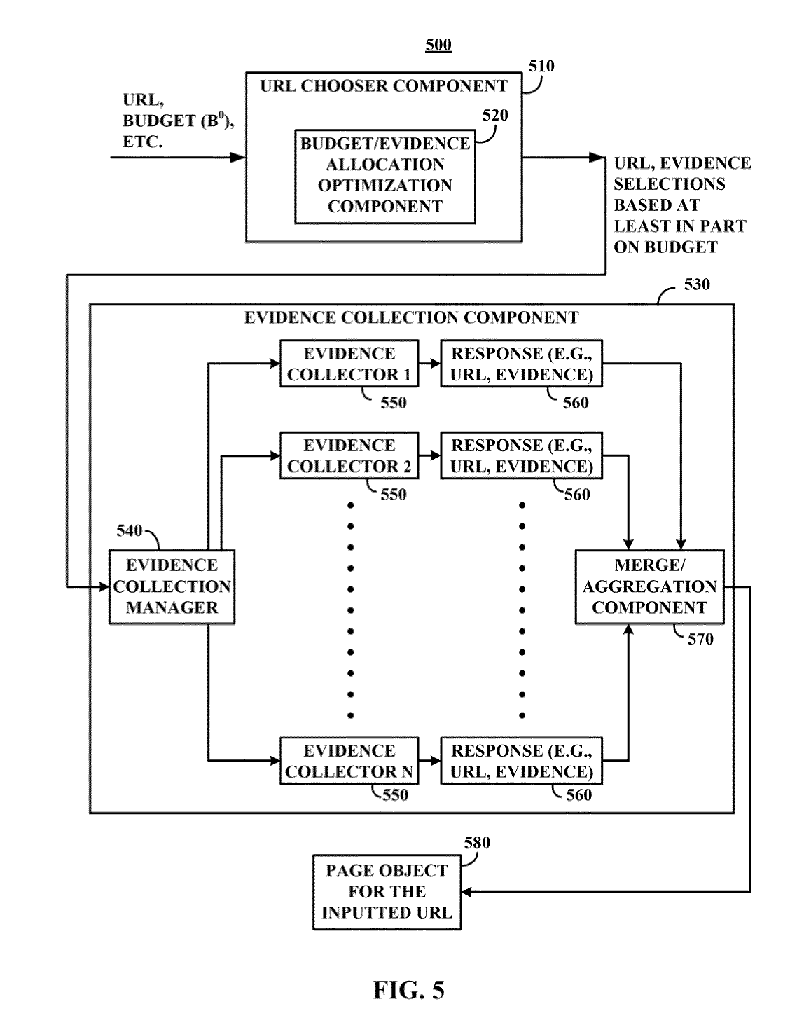

In response to receiving one or more webpages, the rating application or a component of the rating application (e.g., URL chooser component 510 of FIG. 5) selects a uniform resource locator (URL) for rating at 120. In another example, this URL chooser component of the rating application can receive one or more requests from other components (e.g., the most popular requests are assigned a higher priority, particular components of the rating application are assigned a higher priority, random selection from the requests). In yet another example, a fixed, prioritized list of URLs can be defined based, for example, on ad traffic or any other suitable input (e.g., use of the rating for scoring, use of the rating for active learning, etc.).

One or more pieces of evidence can be extracted from the uniform resource locator or page at 130. These pieces of evidence can include, for example, text on the pages, images on the page, etc. As described herein, evidence and/or any other suitable information relating to the page can be collected, extracted, and/or derived using one or more evidentiary sources.

It should be noted that objectionable content on one or more of these webpages can generally be defined as having a severity level worse than (or greater than) bⱼ in a category y. Each category (y) can include various severity groups bⱼ, where j is greater than or equal to 1 through n and n is an integer greater than one. For example, an adult content category can have various severity levels, such as G, PG-13, PG, R, NC-17, and X. In another example, an adult content category and an offensive speech category can be combined to form one category of interest. In yet another example, unlike the adult content category example, a category may not have fine grained severity groups and a binomial distribution, such as the one shown at 150, can be used.

To encode the probability of membership in severity group bⱼ, an ordinomial can be generated at 140. For example, a multi-severity classification can be determined by using an ordinomial to encode the probability of membership in an ordered set of one or more severity groups. The ordinomial can be represented as follows:

∀jε[1,n],p(y=bⱼ|x)

where y is a variable representing the severity class that page x belongs to. It should be noted that the ordinal nature implies that bᵢ is less severe than bⱼ, when i<j. It should also be noted that ordinomial probabilities can be estimated using any suitable statistical models, such as the ones described herein, and using the evidence derived from the pages.

At 150, an ordinomial distribution that includes each generated ordinomial for one or more severity groups can be generated. Accordingly, the cumulative ordinal distribution F can be described as:

F(y=bⱼ|x)=Σᵢ₌₁^{j}p(y=bᵢ|x)

Alternatively, unlike the adult content category example described above, a category may not have fine grained severity groups and a binomial distribution can be used. At 160, in some embodiments, a binary or binomial-probability determination of appropriateness or objectionability can be projected onto an ordinomial by considering the extreme classes—b₁ and bₙ. For example, in cases where a large spectrum of severity groups may not be present, a binomial determination can be performed. Ordinomial probabilities can be estimated using one or more statistical models, for example, from evidence derived or extracted from the received web pages.

It should be noted that, in process 100 of FIG. 1 and other processes described herein, some steps can be added, some steps may be omitted, the order of the steps may be re-arranged, and/or some steps may be performed simultaneously.

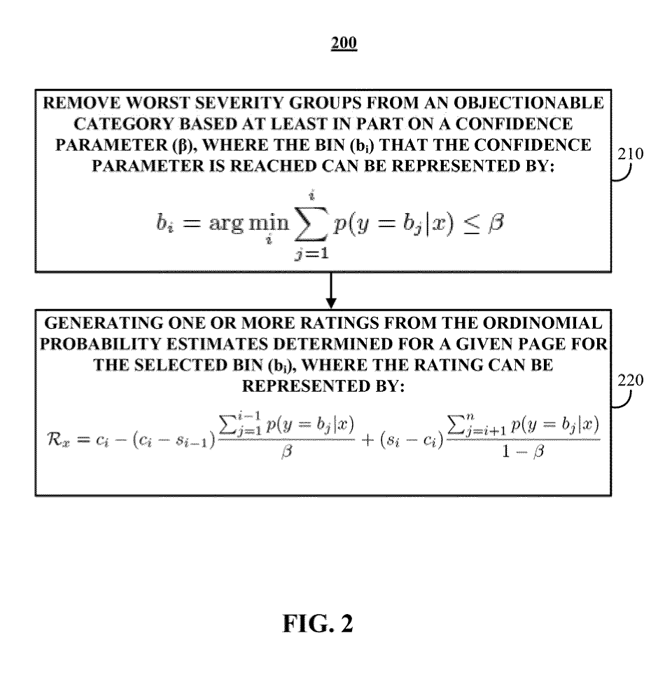

FIG. 2 is a diagram of an example of a process 200 for generating a rating (R) for a webpage in accordance with some embodiments of the disclosed subject matter. Generally speaking, one or more ratings can be determined for a webpage and its ordinomial probability estimates that encode both severity and confidence. That is, a rating (R) associated with a particular ordinomial, p(y=bⱼ|x) that includes severity and confidence parameters is determined. For example, an advertiser may desire that the rating represents a particular confidence that the page's content is no worse than severity group bⱼ. Alternatively, in another example, an advertiser may desire that the rating encodes the confidence that a particular webpage is no better than a particular severity group.

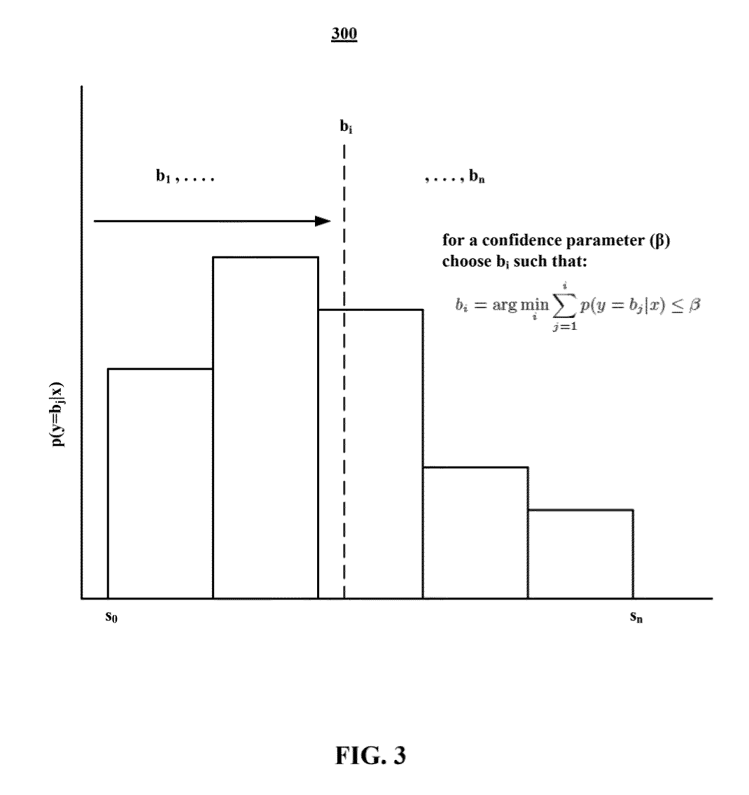

As shown in FIG. 2, process 200 begins by removing the worst severity groups from an objectionable category based at least in part on a confidence parameter (β) at 210. For example, as shown in FIG. 3, starting from the least severe or objectionable category in the ordinomial (b₁), the bins of the ordinomial are ascended, maintaining a sum of the probabilities encountered. The bin, bᵢ, where the level of confidence (β) is reached can be represented by:

$${b}_{i} = arg {min}_{i} {\sum }_{j = 1}^{i} p ( y = {b}_{j} \vert x ) \leq β$$

It should be noted that, when a larger confidence parameter (β) is assigned, a smaller probability mass resides in more severe categories is ensured.

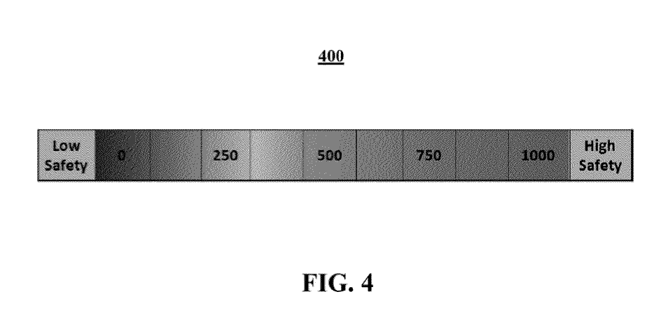

Referring back to FIG. 2, one or more ratings are generated at 220. These ratings are determined from a given page's ordinomial probability estimates and encodes both severity and confidence. It should be noted that the rating application can assume that ratings are given on a numeric scale that can be divided into ranges Bⱼ, where there is a one-to-one mapping between these ranges and the bⱼ. That is, step 210 of process 200 indicates that there is a particular confidence that a page has severity no worse than bj, and the rating (R) is somewhere in the range Bⱼ. For example, as shown in FIG. 4, the rating scale 400 can be 0 through 1000, where 1000 denotes the least severe end or the highly safe portion of the scale. In another example, rating scale 400 can be further divided such that particular portions of rating scale are determined to be the best pages—e.g., ratings falling between 800 and 1000. Accordingly, if a greater than β confidence that the page's content is no worse than the best category, then the page's rating falls in the 800-1000 range.

To determine the rating (R) within the range, boundaries to the rating range (Bⱼ) and a center (cⱼ) of each bin is defined. For example, consider two pages A and B, where page A has 99.9% confidence that the page contains pornography and page B has a confidence of (1−β)+ε that it contains pornography. It should be noted that ε is generally an arbitrarily small number. That is, while page A contains pornography, it cannot be stated with confidence that page B does not contain pornography. Both pages A and B fall in the lowest ratings range. However, the rating application generates a significantly lower rating for page A.

It should be noted that, in some embodiments, interior rating ranges for a particular objectionability category can be defined. For example, the rating application can generate one or more ratings that take into account the difference between being uncertain between R rated content and PG rated content, where R and PG are two interior severity levels within the adult content category. In another example, the rating application can generate one or more ratings that take into account the difference between a page having no evidence of X rated content and a page having some small evidence of containing X rating content.

The boundaries of rating range Bⱼ can be defined as sⱼ₋₁ and sⱼ. In addition, a center cⱼ can be defined for each bin. It should be noted that the center for each bin is not necessarily the middle of the range. Rather, the center is the rating desired by the application should either all probability reside in this range, or should there be balanced probabilities above and below in accordance with a given level of β assurance. Accordingly, the rating given the chosen bin Bᵢ, and the ordinomial encoding of p(y=bⱼ|x) can be represented by:

$${R}_{x} = {c}_{i} - ( {c}_{i} - {s}_{i - 1} ) \frac{{\sum }_{j = 1}^{i - 1} p ( y = {b}_{j} \vert x )}{β} + ( {s}_{i} - {c}_{i} ) \frac{{\sum }_{j = i + 1}^{n} p ( y = {b}_{j} \vert x )}{1 - β}$$

It should be noted that one or more ratings can be generated for one or more objectionable categories.

It should also be noted that, in some embodiments, ratings for two or more objectionable categories can be combined to create a combined score. For example, a first rating generated for an adult content category and a second rating generated for an offensive language category can be combined. Alternatively, weights can be assigned to each category such that a higher weight can be assigned to the adult content category and a lower weight can be assigned to the offensive language category. Accordingly, an advertiser or any other suitable user of the rating application can customize the score by assigning weights to one or more categories. That is, a multi-dimensional rating vector can be created that represents, for each site, the distribution of risk of adjacency to objectionable content along different dimensions: guns, bombs and ammunition; alcohol; offensive language; hate speech, tobacco; spyware and malicious code; illegal drugs; adult content, gaming and gambling; entertainment; illegality; and/or obscenity.

It should further be noted that, as used herein, a site can be an entire domain or a subset of the pages of a domain. To avoid ambiguity, this is sometimes referred to herein as a chapter of the domain, where chapters can be divisible by segmenting URLs. In particular, any substring of a page's URL represents a possible chapter that the page belongs to. The most general chapter is the domain itself (e.g., www.webpage.com) and the most specific chapter is a particular page (e.g., www.webpage.com/whitepapers/techpaper.html). This hierarchical segmentation allows the seamless analysis of popular chapters of different sizes.

In some embodiments, the rating for a page corresponds to the rating for the most specific rated chapter to which the page belongs. For example, an aggregate site rating can be generated from the ratings of individual pages on that site. In another example, when a new URL is selected for rating, the rating application can obtain the rating from the longest available prefix. At one extreme, the rating is for the page itself (e.g., for popular pages). Alternatively, at the other extreme, the rating for a page is derived from the rating for the entire domain. Similarly to assigned weights for categories, the rating application can generate a combined or aggregate rating for a site by combining ratings generated for each page or multiple pages of an entire domain. Alternatively, the rating application can assign weights associated with each page of a domain based on, for example, popularity, the hierarchical site structure, interlinkage structure, amount of content, number of links to that page from other pages, etc.

As described in FIG. 1, evidence and/or any other suitable information relating to a page can be considered. In some cases, a single source of information or evidence derived from a webpage generally does not provide a reliable indicator of the nature of all web pages. Even a typically accurate source of information, such as a page label provided from a third party labeling service, can occasionally be incorrect. To improve upon the deficiencies that any one source of evidence can provide, the rating application considers a heterogeneous mixture of information from multiple evidence sources.

As used herein, these evidence sources can include, for example, the text of the URL, image analysis, HyperText Markup Language (HTML) source code, site or domain registration information, ratings, categories, and/or labeling from partner or third party analysis systems (e.g., site content categories), source information of the images on the page, page text or any other suitable semantic analysis of the page content, metadata associated with the page, anchor text on other pages that point to the page of interest, ad network links and advertiser information taken from a page, hyperlink information, malicious code and spyware databases, site traffic volume data, micro-outsourced data, any suitable auxiliary derived information (e.g., ad-to-content ratio), and/or any other suitable combination thereof.

In some embodiments, the evidence sources collects evidence that can be used for generating a rating. In a more particular embodiment, the evidence sources include one or more evidence collectors that obtain input from, for example, the URL selection component of the rating application, for the next URL to rate. The evidence sources can also include one or more evidence extractors that extract evidence from the page—e.g., milabra or any other suitable image or video analyzer, who is to determine domain registration information, etc.

It should be noted, however, that gathering any subset of evidence relating to a particular page incurs a cost associated with gathering, collection, and organization of such evidence. Accordingly, the rating application provides an approach for budget-constrained evidence acquisition.

If particular evidence for a page (pᵢ) is represented as:

e_{j,p}_{ᵢ}εEₚ_{ᵢ}

then the cost of acquiring this particular evidence for the page can be represented by:

c(e_{j,p}_{ᵢ})

Assuming that the costs of each source of evidence are independent, the total acquisition cost for a page pᵢ can then be represented by:

Σe_{j,p}_{ᵢ}εEₚ_{ᵢ}c(e_{j,p}_{ᵢ})

In response to receiving a budget parameter (B) for acquiring evidence for a particular page (pᵢ) (e.g., a limited budget), the evidence collection component of the rating application selects a subset of evidence that adheres to the budget parameter. For example:

Σe_{j,p}_{ᵢ}εÊₚ_{ᵢ}c(e_{j,p}_{ᵢ})≦Bₚ_{ᵢ}^{o}.

In some embodiments, the budget parameter (B) can be defined initially by a page selection mechanism (e.g., URL chooser component 510 of FIG. 5), any suitable component of the rating application, or any suitable entity. For example, a budget parameter can be defined by an advertising entity. In another suitable example, a budget parameter can be defined by a URL selection component of the rating application. This approach captures the value of acquiring improved ratings on a given page. That is, adding additional evidence to a particular classification component tends to increase the performance of that classification component. Since increasing the budget for a particular URL monotonically allows more evidence to be collected for that URL, allowing additional budget for a URL tends to lead to more accurate inferences to be made for that URL. The budget parameter for a particular page can then be determined by the value for achieving correct classifications on a give web page as a portion of a periodic evidence budget pool.

Alternatively, in some embodiments, a initial budget can be provided to those pages deemed valuable for processing, where:

Bₚ_{ᵢ}^{o}=B^{o}

For example, an initial budget B^{o} can be inputted into a rating model that includes a budget parameter. After the rating model is trained, subsequent budget parameters can be inputted into the model.

In some embodiments, the rating application can use a rating utility (u) for a given page for each type of evidence (eⱼ). This rating utility can, for example, encode the probability of rating correctness given a certain type of evidence. This can be represented by:

u(e_{j,p}_{ᵢ})=u(eᵢ)

In response to receiving an initial budget parameter, the rating application, with the use of the evidence collection component described herein, determines a subset of evidence deemed to be beneficial as constrained by the budget parameter. This can be represented by the following optimization formula:

$$arg {max}_{{\hat{E}}_{{p}_{i}}} {\sum }_{{e}_{j , {p}_{i}} ∈ {\hat{E}}_{{p}_{i}}} u ( {e}_{j , {p}_{i}} )$$

The above-mentioned formula is constrained by the initial budget parameter, which can be represented as:

$${\sum }_{{e}_{j , {p}_{i}} ∈ {\hat{E}}_{{p}_{i}}} c ( {e}_{j , {p}_{i}} ) \leq {B}_{{p}_{i}}^{o}$$

For evidence acquisition, it should also be noted that efficient requesting and aggregation of evidentiary information is considered in the rating application. For example, certain types of evidence can have a substantial latency between the initial information request and the actual evidence being supplied in response. In a more particular example, gathering the page text for a URL can require asynchronous crawling of that page. The latency required for the acquisition of certain types of evidence necessitates load balancing, sharing the workload across several servers via replication in order to ensure useful throughput.

It should further be noted that latencies can differ for differing information or evidentiary requests. For example, certain types of evidence can be accessible through a key-value database, which has virtually no latency. In another example, gathering page text for a URL using a crawler can have substantial latency.

FIG. 5 is a diagram of an illustrative URL chooser component and an illustrative evidence collection component in accordance with some embodiments of the disclosed subject matter. In particular, these components of the rating application taking into account budget parameters and load balancing to generate a page object.

As shown in FIG. 5, a URL or any other identifying information relating to a page and an initial budget parameter are provided to URL chooser component 510. As described previously, URL chooser component 510 can select a page based on, for example, page popularity, ad traffic, and/or any other suitable criteria. Alternatively, the rating application can receive a request from any suitable entity (e.g., an advertiser, another component of the rating application, etc.) to rate a particular page and, in response, the URL or page information is transmitted to URL chooser component 510.

In some embodiments, URL chooser component 510 or any other suitable component of the rating system can prioritize the URLs that are processed and/or rated. For example, URL chooser component 510 may consider one or more factors in making such as prioritization, such as the frequency of occurrence in the advertisement stream, the frequency and nature of the changes that occur on a particular page, the nature of the advertisers that would tend to appear on a page, and the expected label cost/utility for a given page.

In other embodiments, URL chooser component 510 can select random pages from a traffic stream. In yet another embodiment, URL chooser component 510 can select uniformly from observed domains with a subsequent random selection from pages encountered within the selected domain, thereby providing coverage to those domains that are encountered less frequently in the traffic stream.

Alternatively, URL chooser component 510 can select those URLs based on a determination of amortized utility. In particular, URL chooser component 510 can determine the amortized value of this information and select particular URLs with the most favorable amortized utility. In some embodiments, URL chooser component 510 can take random samples from a distribution of URLs based on the amortized utility, thereby providing coverage to those URLs with the most favorable amortized utility, while also providing coverage to URLs that are determined to have a less favorable amortized utility.

In some embodiments, URL chooser component 510 includes a budget/evidence allocation optimization component 520. Component 520 determines how much in budgetary resources the rating application affords for the particular URL. For example, component 520 can, using the initial budget parameter and reviewing the available evidentiary sources and their corresponding information, determine a subset of the evidentiary sources to be used as constrained by the initial budget parameter. In response to this determination, URL chooser component transmits an initial evidence request to evidence collection component 530. The initial evidence request can include, for example, the URL or identifying information relating to the page and a subset of evidence sources (e.g., use evidence sources to review the HTML source code, the text of the URL, the page text, and the site/domain registration information, but do not use evidence sources to analyze the images on the page).

Referring back to FIG. 5, evidence collection component 530 includes an evidence collection manager 540 that receives the evidence request. In response to receiving the evidence request, evidence collection manager 540 directs a portion of the evidence request to the appropriate evidence collectors 550. As shown, evidence collection component 530 includes multiple evidence collectors 550. Each evidence collector 550 can manage a particular type of evidence request—e.g., one evidence collector for obtaining HTML source code of the page and another evidence collector for image analysis. More particularly, upon receiving an instruction or a request from evidence collection component 530, an evidence collector 550 performs a process to obtain evidence that responds to the request. For example, evidence collection manager 540 can receive a request to obtain evidence relating to the HTML code associated with the page and, in response to receiving the request, transmits the request to the appropriate evidence collector 550 that retrieves the HTML code associated with the particular page. It should be noted that evidence collectors 550 can include one or more individual processes, which can be across one or more servers.

In response to receiving an individual request from evidence collection manager 540, each requested evidence collector 550 generates a response. For example, in some embodiments, evidence collector 550 can generate a [URL, evidence] tuple or any other suitable data element. In another example, evidence collector 550 can obtain the evidence (if available) and populate records in a database. The response can be stored in any suitable storage device along with the individual request from evidence collection manager 540.

Referring back to FIG. 5, the responses 560 from multiple evidence collectors 550 can be combined, using a merge/aggregation component 570, into a page object 580.

In a more particular embodiment, an asynchronous implementation may be provided that uses merge/aggregation component 570. Component 570 can be used to join the responses 560 obtained by evidence collectors 550. For example, component 570 can perform a Map/Reduce approach, where a mapping portion concatenates the input and leaves the [URL, evidence] tuples or other evidentiary portion of the response unchanged. In addition, a reduction portion of component 570 can be used to key the URL or page identifying portion of the response. For example, component 570 can combine responses 560 such that evidence with a particular URL key can be available to an individual processor that merges this data into a page object that can be stored for consumption by a consumer process.

Generally speaking, the evidence that is obtained from multiple evidentiary sources, whether combined into a page object 580, is generally not suitable for use by the rating application. More particularly, a classification component of the rating system, which can include rating models, cannot generally use this evidence directly from evidence collection component 530.

In some embodiments, the rating application converts the page object (responses and evidence obtained from multiple evidentiary sources as instructed by evidence collection component 530) into a suitable instance for processing by a classification component or any other suitable machine learning mechanism. As used herein, an instance is a structured collection of evidence corresponding to a particular page.

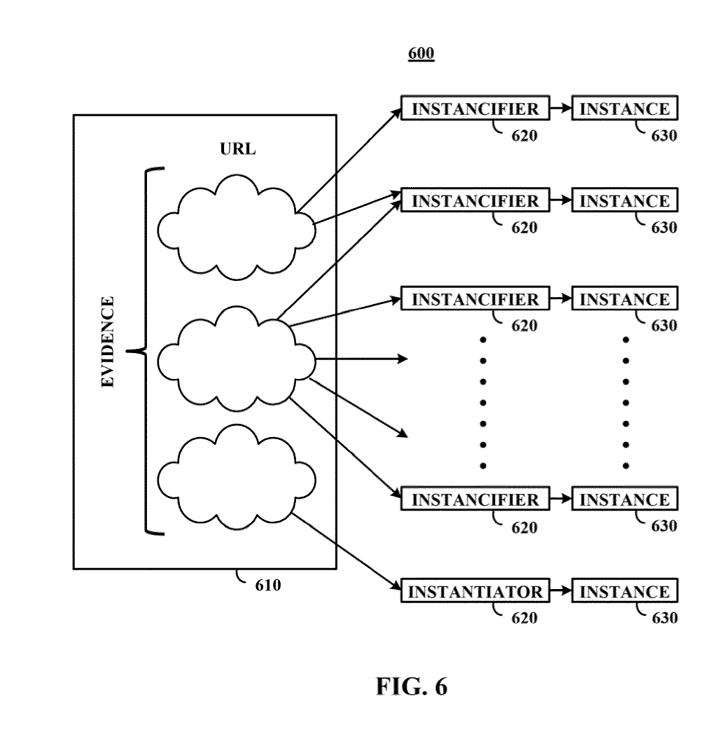

As shown in FIG. 6, the rating system, as shown in process 600, uses one or more instancifiers 620, where each instancifier maps information from one or more pieces of obtained evidence 610 from a page object to a particular instance 630 for consumption by a classification component of the rating application or any other suitable machine learning mechanism. Each instancifier can be used to map particular features of evidence.

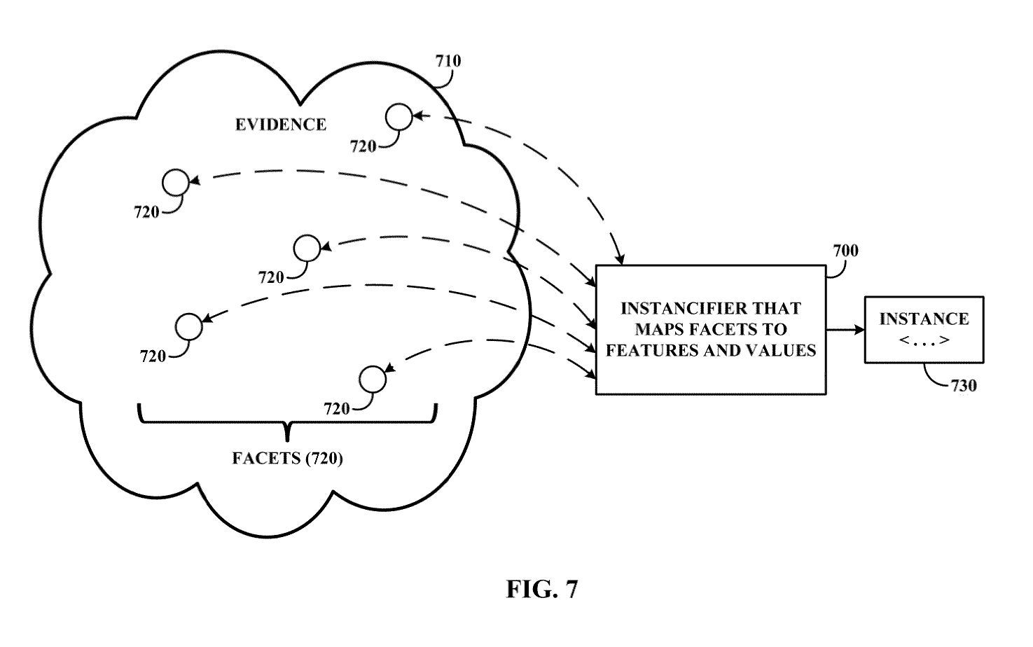

More particularly, FIG. 7 shows an illustrative instancifier 700 in accordance with some embodiments of the disclosed subject matter. Instancifier 700 maps one or more facets 720 contained in the input evidence 710 (e.g., page object) into an instance 740. In some embodiments, the facets 720 are mapped to one or more feature/value pairs, where these feature/value pairs populate a particular instance for use by a classification component of the rating application or any other suitable machine learning mechanism.

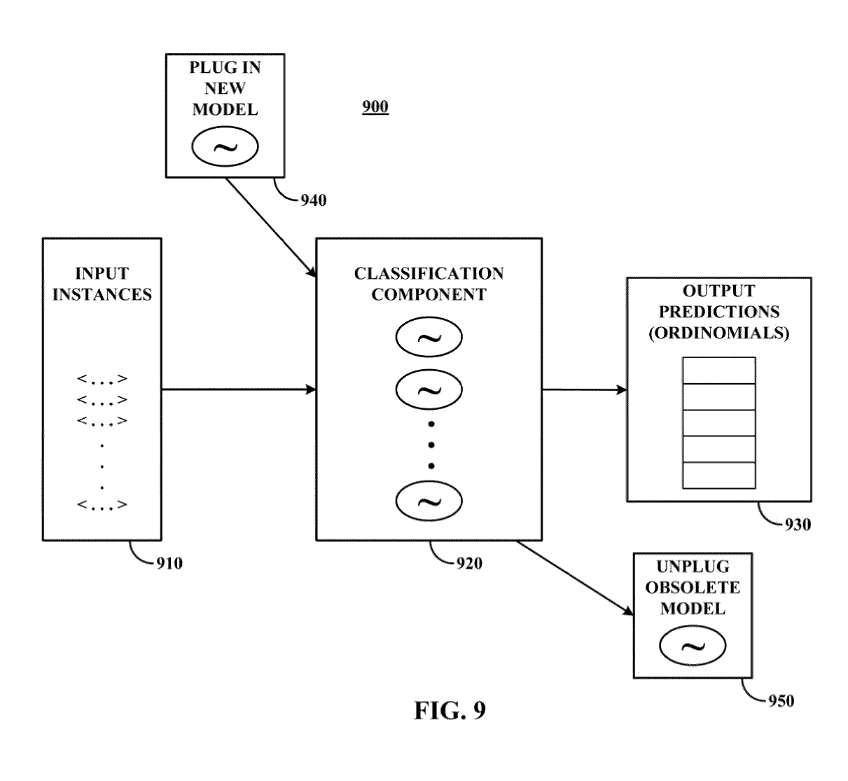

Upon obtaining a structured collection of evidence that corresponds to a particular page, the rating application uses these instances to generate a rating for the page. The rating application can include one or more rating models and one or more combining models (which are collectively referred to herein as “the rating model”) and one or more inference procedures. For example, as shown in FIG. 9, a classification component of the rating application includes multiple rating models.

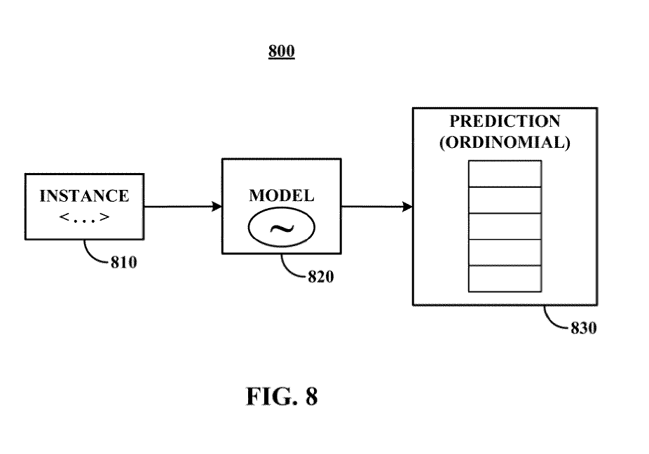

As shown in FIG. 8, instances 810 (e.g., from instancifier 700 of FIG. 7) are inputted into the rating model 820 to obtain an outputted prediction 830. In particular, a model fₖ (•) takes as input an instance x_{1,pi} that is derived from a set of evidence, ∪eₚ_{ᵢ}, processes the instance in accordance with the model, and generates an output ordinomial. As described above, the output ordinomial provides the estimated probabilities that page pᵢ belongs in the various severity classes of a single category.

In some embodiments, the rating models used in the rating application are modular. For example, as shown in FIG. 9, the rating application includes pluggable models that can be inserted and removed from classification component 920. In general, classification component 920 receives input instances 910 and generates output predictions in the form of ordinomials 930. As also shown in FIG. 9, classification component 920 as well as any suitable portion of the rating application can be configured to facilitate the seamless inclusion and removal of models. For example, as improved machine learning approaches or improved models are developed, an updated model 940 can be introduced to classification component 920. Similarly, obsolete models 950 can be removed from classification component 920.

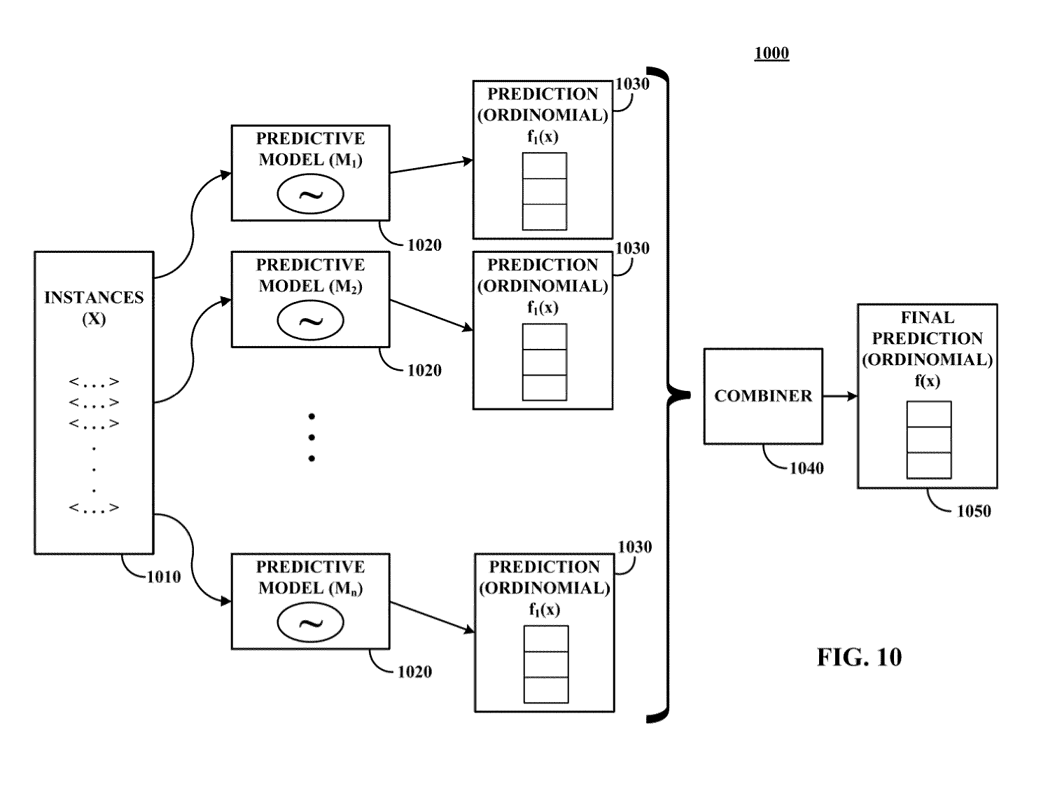

It should be noted that, as shown in FIG. 8, each model in classification component 920 generates a prediction. As there are multiple instances resulting from multiple pieces of evidence from multiple evidentiary sources, classification component 920 includes multiple models (as illustrated in FIG. 9). Accordingly, as shown in FIG. 10, the rating application includes a combiner 1040 for combining or fusing the predictions (ordinomials) 1030 from each model 1020 into a final prediction or final output ordinomial 1050.

As described previously, the final output ordinomial 1050 can be used to generate a rating. For example, as shown in FIG. 4, the rating scale can be a numerical scale from 0 through 1000, where 1000 represents the least severe end or the substantially safe portion of the scale. One or more ratings can be generated for each category of objectionable content (e.g., adult content, guns, bombs, ammunition, alcohol, drugs, tobacco, offensive language, hate speech, obscenities, gaming, gambling, entertainment, spyware, malicious code, and illegal content.)

In some embodiments, rating models can take the available evidence and the multiple ordinomials, and combine them to obtain a page's final aggregate ordinomial vector or output. This can be performed using any suitable approach. For example, a linear model can treat each piece of evidence as a numeric input, apply a weighting scheme to the evidence, and transmit the result to a calibration function that generates the final aggregate ordinomial. Alternatively, a non-linear model can consider different evidence differently, depending on the context. Nevertheless, the rating model can be a combination of sub-models and other associated evidence. For example, the output of a semantic model can be the input to the next layer of modeling.

For a set of instances xεX describing one page, classification component 920 of FIGS. 9 and 10 receives each input instance 1010 and generates an individual prediction 1030 in the form of an ordinomial, resulting in a set of predictions, {f(x)}.

It should further be noted that an individual model or a class of models can have biases that lead to mistaken inferences. Accordingly, in some embodiments, an ensemble of predictors or rating models, f (•), for a given instance x is provided. Generally, the ensemble is a collection of multiple prediction or rating models, where the output of the ensemble is combined to smooth out the biases of the individual models. That is, as different models have different biases and provide different predictions or outputs, some of which are mistaken due to a bias associated with a particular model, the combination of outputs in the ensemble reduces the effect of such mistaken inferences.

For a given set of instances, xεX, an ensemble that includes individual models, f, each making an output prediction, can be represented by:

∪f(x),xεX

In response to receiving multiple predictions from the multiple models of the ensemble, the ensemble can generate a final prediction or a combined ordinomial of probability estimates. The combiner 1040 can include a final combining model, g, that returns a combined ordinomial of probability estimates. This can be represented by:

\hat{p}(y=bⱼ|x)=g(∪f(x),xεX)

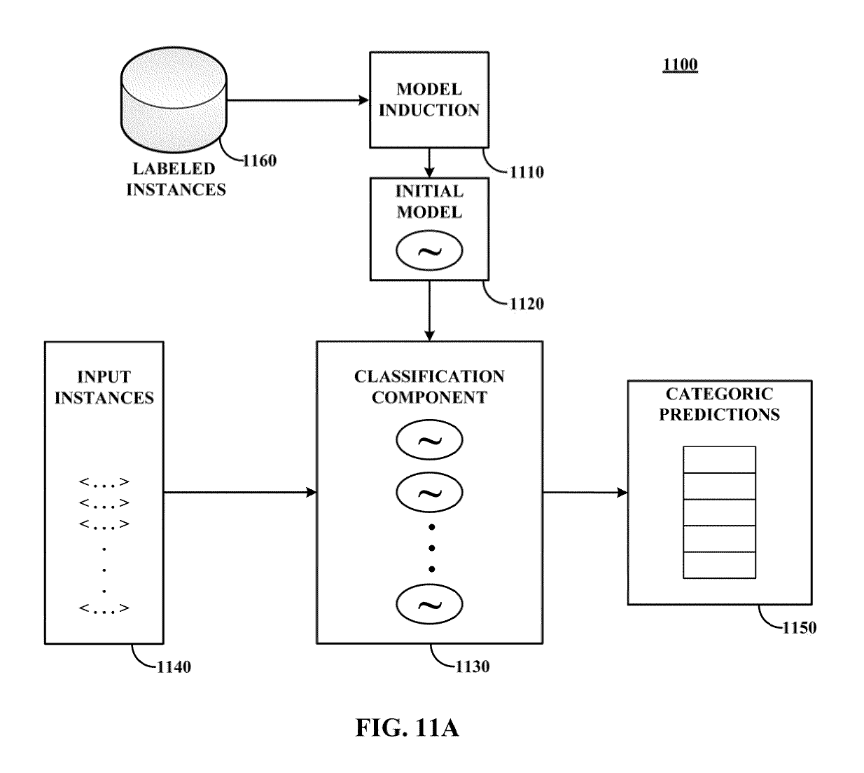

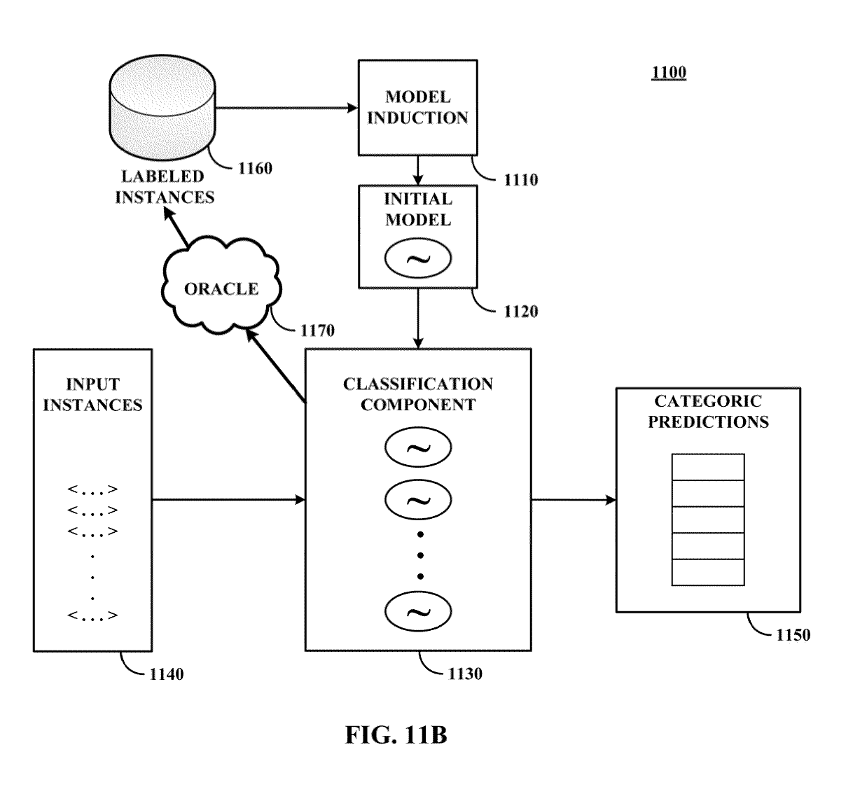

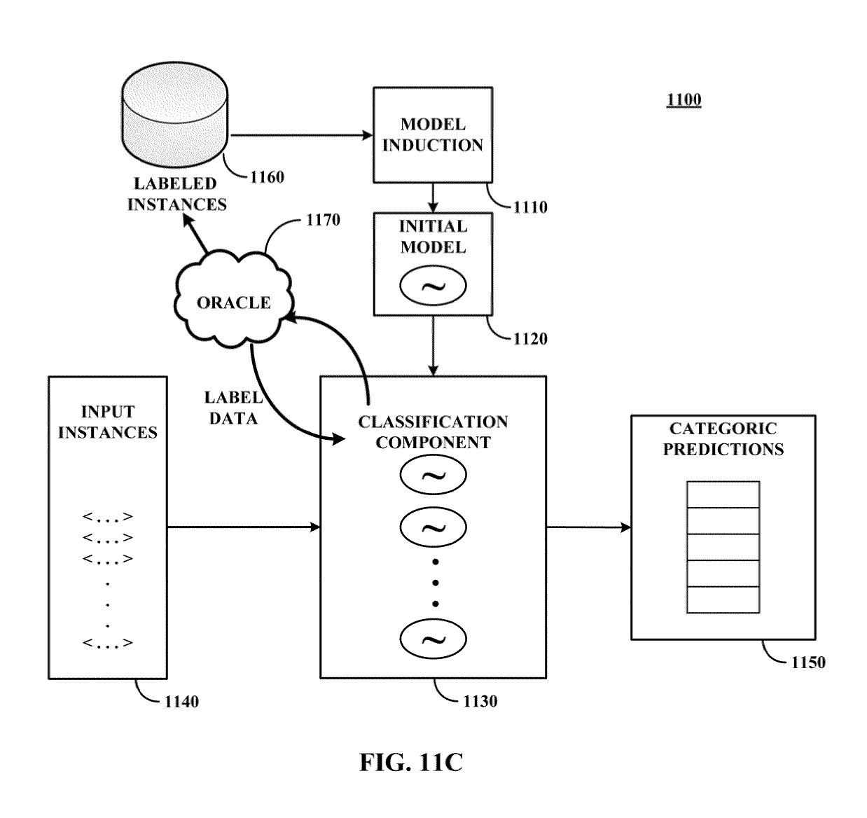

In some embodiments, the models used in the rating application can be trained using a training set of data. For example, when training a new model in the classification component of the rating application, a training set can include input instances that that the model of the rating application would likely receive from a real-time instancifier. In addition, the training set can include prediction outputs (e.g., labels) denoting the appropriate classification for a particular instance in the training set. This is shown, for example, in FIG. 11A. FIG. 11A includes a model induction component 1110 that uses training data to train initial model 1120. After initial model 1120 is trained with the training data, the rating application can insert initial model 1120 (e.g., using the modular model approach described above) into classification component 1130, where initial model 1120 and the other models of classification component 1130 receive actual input instances 1140 and generate ordinomial outputs 1150.

In a more particular example, FIG. 11A illustrates a batch training approach, where a set of labeled instances 1160 are used to train initial model 1120. The set of labeled instances can include a set of input instance data and a corresponding set of labels that initial model 1120 should associate with the particular input instance data.

In some embodiments, an active learning approach to training the models used in the rating application can be used. For example, there may be some cases where some subset of instances should be considered for human labeling (for training data). FIG. 11B illustrates an active learning approach, where an oracle 1170 is included in the rating application. As shown, after an initial training, an existing predictive model or rating model assigns a utility or weight to unlabeled instances. Those instances with greater utility are sent to oracle 1170 for labeling, while instances with lesser utility are not. The instance/label pairs and/or any other suitable classification data is inserted into a database and model induction component 1110 can use the training data supplemented with the instance/label pairs inserted in the database for training a new model, such as initial model 1120.

Alternatively or additionally, an online active learning approach to training the models used in the rating application can be used. Using the online active learning approach, one or more models in classification component 1130 can be updated with the instance/label pairs received from oracle 1170. For example, as shown in FIG. 11C, one or more models in classification component 1130 can be continuously trained by adding training data from oracle 1170.

These and other approaches for guided learning and hybrid learning are also described in Attenberg et al., U.S. Provisional Patent Application No. 61/349,537, which is hereby incorporated by reference herein in its entirety.

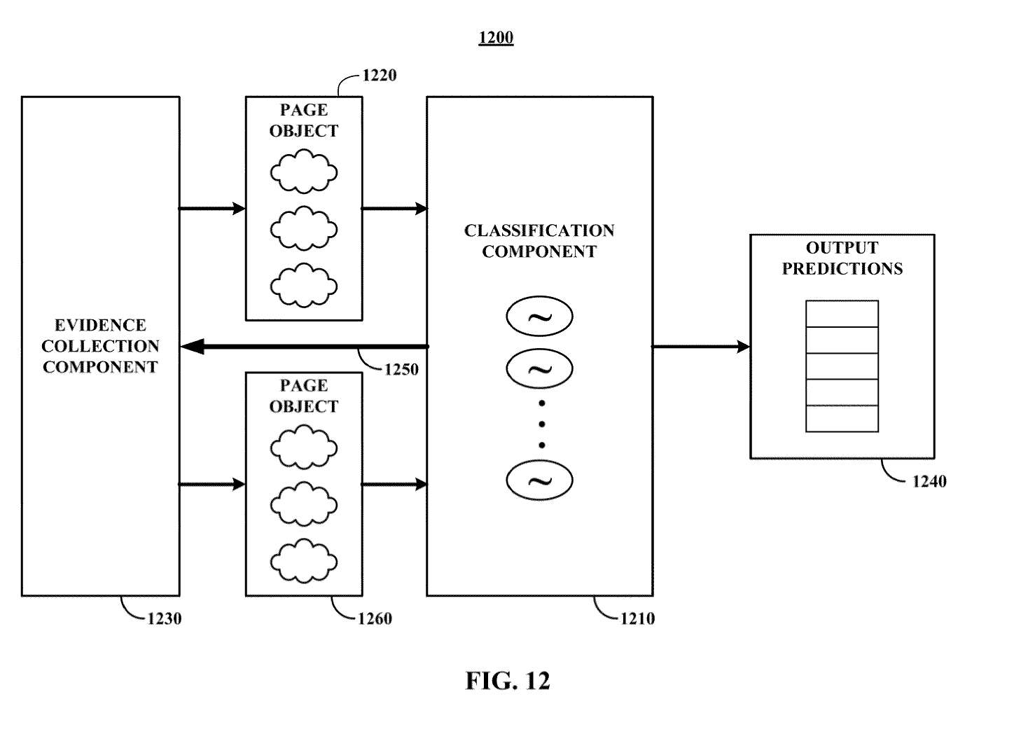

In some embodiments, the classification component of the rating application is provided with insufficient evidence to generate a prediction. As shown in FIG. 12, while classification component 1210 receives page objects 1220 from evidence collection component 1230, classification component 1210 has insufficient evidence to generate output predictions 1240. Accordingly, classification component 1210 and other components of the rating application can include a feedback mechanism.

As shown in FIG. 12, classification component 1210 can use feedback information 1250 (e.g., insufficient evidence) to communicate with evidence collection component 1230. For example, feedback information 1250 can include a request for additional evidence from a different evidentiary source (e.g., an evidentiary source not previously requested), a request for missing evidence (e.g., a page object transmitted to the classification component does not include any evidence), a verification request as received evidence is a particular distance (error) from monitored evidence, etc.

In response, evidence collection component 1230 can transmit a response to the feedback information in the form of an updated page object 1260. For example, updated page object 1260 can include the additional requested evidence. Classification component 1210 can, using updated page object 1260, generate an output prediction 1240.

In some embodiments, the rating application can take into account the network context in which a page appears. Generally speaking, an objectionable page (e.g., a page that includes pornography) is likely to be linked to other objectionable pages. Conversely, a pristine page without objectionable content is unlikely to link to objectionable pages.

For example, in some embodiments, as an evidentiary source, the evidence collection component can, for a given page, extract the links associated with the page. In some embodiments, the evidence collection component can also collect links from pages that point to the given page and their associated URLs. In response to extract this network context information relating to a page, the classification component can generate ratings (e.g., output predictions) for the page and each of the linked pages. Another source of evidence can be created, where ratings and the linked pages are instancified. In addition, other calculations (e.g., an average score of linked pages) can be performed based on the network context information.

In another example, the rating application can identify particular network context information as in-links (links from pages pointing to a given page) and out-links (links from the given page to other pages). A model in the classification component can be created that uses the network context information to create a particular output prediction. For example, a model in the classification component can determine whether a link and network context information received in a page object is more likely to appear on an objectionable page.

In yet another example, the rating application can use the network context information to consider the network connections themselves. For example, inferences about particular pages (nodes in the network) can be influenced not only by the known classifications (ordinomials) of neighboring pages in the network, but also by inferences about the ratings of network neighbors. Accordingly, objectionability can propagate through the network through relaxation labeling, iterative classification, Markov-chain Monte Carlo techniques, graph separation techniques, and/or any other suitable collective inference techniques.

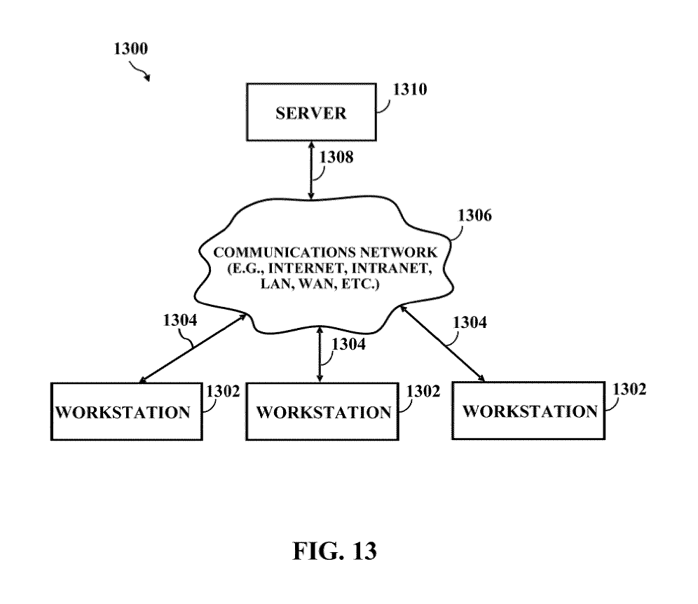

FIG. 13 is a generalized schematic diagram of a system 1300 on which the rating application may be implemented in accordance with some embodiments of the disclosed subject matter. As illustrated, system 1300 may include one or more user computers 1302. User computers 1302 may be local to each other or remote from each other. User computers 1302 are connected by one or more communications links 1304 to a communications network 1306 that is linked via a communications link 1308 to a server 1310.

System 1300 may include one or more servers 1310. Server 1310 may be any suitable server for providing access to the application, such as a processor, a computer, a data processing device, or a combination of such devices. For example, the application can be distributed into multiple backend components and multiple frontend components or interfaces. In a more particular example, backend components, such as data collection and data distribution can be performed on one or more servers 1310. Similarly, the graphical user interfaces displayed by the application, such as a data interface and an advertising network interface, can be distributed by one or more servers 1310 to user computer 1302.

More particularly, for example, each of the client 1302 and server 1310 can be any of a general purpose device such as a computer or a special purpose device such as a client, a server, etc. Any of these general or special purpose devices can include any suitable components such as a processor (which can be a microprocessor, digital signal processor, a controller, etc.), memory, communication interfaces, display controllers, input devices, etc. For example, client 1302 can be implemented as a personal computer, a personal data assistant (PDA), a portable email device, a multimedia terminal, a mobile telephone, a set-top box, a television, etc.

In some embodiments, any suitable computer readable media can be used for storing instructions for performing the processes described herein, can be used as a content distribution that stores content and a payload, etc. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during-transmission, and/or any suitable intangible media.

Referring back to FIG. 13, communications network 1306 may be any suitable computer network including the Internet, an intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), or any combination of any of such networks. Communications links 1304 and 1308 may be any communications links suitable for communicating data between user computers 1302 and server 1310, such as network links, dial-up links, wireless links, hard-wired links, any other suitable communications links, or a combination of such links. User computers 1302 enable a user to access features of the application. User computers 1302 may be personal computers, laptop computers, mainframe computers, dumb terminals, data displays, Internet browsers, personal digital assistants (“PDAs”), two-way pagers, wireless terminals, portable telephones, any other suitable access device, or any combination of such devices. User computers 1302 and server 1310 may be located at any suitable location. In one embodiment, user computers 1302 and server 1310 may be located within an organization. Alternatively, user computers 1302 and server 1310 may be distributed between multiple organizations.

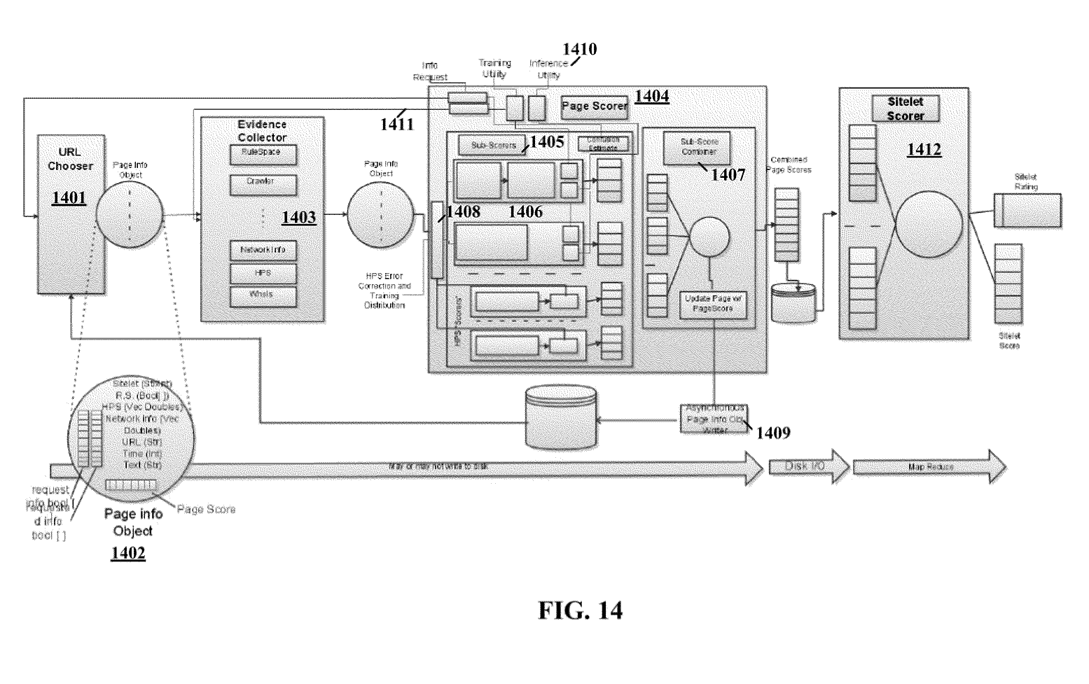

In a more particular embodiment, FIG. 14 is a diagram of an illustrative architecture for the rating application. Various components of the rating application are shown. For example, the rating application can include: a URL chooser component 1401 that selects URLS and initial evidence or subsequent analysis; a page info object 1402 for communicating evidence on the page and requests for additional evidence from one or more evidentiary sources; an evidence collection component 1403 for gathering evidence with the use of an evidence collection manager and evidence collectors; a page scoring management component 1404 for receiving evidence and instances for generating prediction outputs; a model management component 1405 for managing and training the one or more rating and/or combining models used in the rating application; individual classification models 1406 for determining posterior distributions using statistical learning; an estimate aggregation/combination component 1407 for combining output from various models; human label error correction 1408 for training and updating rating models; score caching component 1409; inference component 1410 for determining utility estimates for active learning and/or active feature value acquisition; feedback communication channels 1411 for obtaining additional evidence, labels, and/or providing feedback to other components of the rating application; and site level aggregation and rating component 1412.

It should be noted that each of these components of the rating application can be practiced in a distributed computing environment, where tasks are performed by remote processing devices that are linked through a communications network. In a distributed computing environment, these components or any other suitable program module can be located in local and/or remote computer storage media.

Referring back to FIG. 13, the server and one of the user computers depicted in FIG. 13 are illustrated in more detail in FIG. 14. Referring to FIG. 14, user computer 1302 may include processor 1402, display 1404, input device 1406, and memory 1408, which may be interconnected. In a preferred embodiment, memory 1408 contains a storage device for storing a computer program for controlling processor 1402.

Processor 1402 uses the computer program to present on display 1404 the application and the data received through communications link 1304 and commands and values transmitted by a user of user computer 1302. It should also be noted that data received through communications link 1304 or any other communications links may be received from any suitable source. Input device 1406 may be a computer keyboard, a cursor-controller, dial, switchbank, lever, or any other suitable input device as would be used by a designer of input systems or process control systems.

Server 1310 may include processor 1420, display 1422, input device 1424, and memory 1426, which may be interconnected. In a preferred embodiment, memory 1426 contains a storage device for storing data received through communications link 1308 or through other links, and also receives commands and values transmitted by one or more users. The storage device further contains a server program for controlling processor 1420.

In some embodiments, the application may include an application program interface (not shown), or alternatively, the application may be resident in the memory of user computer 1302 or server 1310. In another suitable embodiment, the only distribution to user computer 1302 may be a graphical user interface (“GUI”) which allows a user to interact with the application resident at, for example, server 1310.

In one particular embodiment, the application may include client-side software, hardware, or both. For example, the application may encompass one or more Web-pages or Web-page portions (e.g., via any suitable encoding, such as HyperText Markup Language (“HTML”), Dynamic HyperText Markup Language (“DHTML”), Extensible Markup Language (“XML”), JavaServer Pages (“JSP”), Active Server Pages (“ASP”), Cold Fusion, or any other suitable approaches).

Although the application is described herein as being implemented on a user computer and/or server, this is only illustrative. The application may be implemented on any suitable platform (e.g., a personal computer (“PC”), a mainframe computer, a dumb terminal, a data display, a two-way pager, a wireless terminal, a portable telephone, a portable computer, a palmtop computer, an H/PC, an automobile PC, a laptop computer, a cellular phone, a personal digital assistant (“PDA”), a combined cellular phone and PDA, etc.) to provide such features.

It will also be understood that the detailed description herein may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

Accordingly, systems, methods, and media for rating websites for safe advertising are provided.

it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for rating webpages for safe advertising, the method comprising:
receiving a uniform resource locator corresponding to a webpage;
selecting a plurality of evidentiary sources for obtaining evidence relating to the uniform resource locator, wherein each piece of evidence corresponds to one of the plurality of evidentiary sources;
converting each piece of evidence obtained from the plurality of evidentiary sources into a plurality of instances that describe the webpage;
applying the plurality of instances to a plurality of rating models, wherein each of the plurality of rating models generates an ordinomial and wherein the ordinomial encodes a probability of membership in one or more severity classes of a category;
combining the ordinomial from each of the plurality of rating models into a combined ordinomial probability estimate; and
generating a rating for the webpage based at least in part on the combined ordinomial probability estimate, wherein the rating identifies whether the webpage is likely to contain objectionable content of the category.

2. The method of claim 1, wherein the plurality of evidentiary sources are selected based at least in part on a budget parameter.

3. The method of claim 2, further comprising determining an optimized subset of evidentiary sources based at least in part on the plurality of evidentiary sources, the uniform resource locator, and the budget parameter.

4. The method of claim 1, further comprising merging each piece of evidence obtained from the plurality of evidentiary sources into a page object associated with the uniform resource locator.

5. The method of claim 4, further comprising receiving feedback relating to the evidence obtained from the plurality of evidentiary sources, wherein additional evidence is collected in response to receiving the feedback and wherein a revised page objected is created.

6. The method of claim 1, wherein each instance maps facets from the obtained evidence with a particular feature.

7. The method of claim 1, wherein the plurality of rating models are modular such that a rating model can be inserted and removed from the plurality of rating models applied to the plurality of instances.

8. The method of claim 1, wherein the category includes at least one of: adult content, guns, bombs, ammunition, alcohol, drugs, tobacco, offensive language, hate speech, obscenities, gaming, gambling, entertainment, spyware, malicious code, and illegal content.

9. The method of claim 1, further comprising:
generating an ordinomial distribution that includes each ordinomial for the one or more severity classes;
receiving a confidence parameter; and
removing at least one of the one or more severity classes based at least in part on the confidence parameter.

10. The method of claim 1, further comprising applying weights to each piece of evidence obtained from the plurality of evidentiary sources.

11. The method of claim 1, further comprising applying weights to each of the plurality of rating models.

12. The method of claim 1, further comprising training at least one of the plurality of rating models with labeling instances.

13. The method of claim 1, further comprising:
using the plurality of rating models to assign a utility to unlabeled instances; and
transmitting unlabeled instances having an assigned utility that is greater than a predetermined value to an oracle for labeling.

14. The method of claim 1, further comprising:
receiving a plurality of uniform resource locators associated with a plurality of webpages; and
generating a priority list of the plurality of uniform resource locators, wherein the priority list is generated based on one of: frequency of each uniform resource locator in an advertisement stream, frequency of changes on the webpage associated with each uniform resource locator, page popularity of each uniform resource locator, and a utility estimate of each uniform resource locator.

15. A system for rating webpages for safe advertising, the system comprising:
a processor that:
receives a uniform resource locator corresponding to a webpage;
selects a plurality of evidentiary sources for obtaining evidence relating to the uniform resource locator, wherein each piece of evidence corresponds to one of the plurality of evidentiary sources;
converts each piece of evidence obtained from the plurality of evidentiary sources into a plurality of instances that describe the webpage;
applies the plurality of instances to a plurality of rating models, wherein each of the plurality of rating models generates an ordinomial and wherein the ordinomial encodes a probability of membership in one or more severity classes of a category;
combines the ordinomial from each of the plurality of rating models into a combined ordinomial probability estimate; and
generates a rating for the webpage based at least in part on the combined ordinomial probability estimate, wherein the rating identifies whether the webpage is likely to contain objectionable content of the category.

16. The system of claim 15, wherein the plurality of evidentiary sources are selected based at least in part on a budget parameter.

17. The system of claim 16, wherein the processor is further configured to determine an optimized subset of evidentiary sources based at least in part on the plurality of evidentiary sources, the uniform resource locator, and the budget parameter.

18. The system of claim 15, the processor is further configured to merge each piece of evidence obtained from the plurality of evidentiary sources into a page object associated with the uniform resource locator.

19. The system of claim 18, the processor is further configured to receive feedback relating to the evidence obtained from the plurality of evidentiary sources, wherein additional evidence is collected in response to receiving the feedback and wherein a revised page objected is created.

20. The system of claim 15, wherein each instance maps facets from the obtained evidence with a particular feature.

21. The system of claim 15, wherein the plurality of rating models are modular such that a rating model can be inserted and removed from the plurality of rating models applied to the plurality of instances.

22. The system of claim 15, wherein the category includes at least one of: adult content, guns, bombs, ammunition, alcohol, drugs, tobacco, offensive language, hate speech, obscenities, gaming, gambling, entertainment, spyware, malicious code, and illegal content.

23. The system of claim 15, the processor is further configured to:
generate an ordinomial distribution that includes each ordinomial for the one or more severity classes;
receive a confidence parameter; and
remove at least one of the one or more severity classes based at least in part on the confidence parameter.

24. The system of claim 15, the processor is further configured to apply weights to each piece of evidence obtained from the plurality of evidentiary sources.

25. The system of claim 15, the processor is further configured to apply weights to each of the plurality of rating models.

26. The system of claim 15, the processor is further configured to train at least one of the plurality of rating models with labeling instances.

27. The system of claim 15, the processor is further configured to:
use the plurality of rating models to assign a utility to unlabeled instances; and
transmit unlabeled instances having an assigned utility that is greater than a predetermined value to an oracle for labeling.

28. The system of claim 15, the processor is further configured to:
receive a plurality of uniform resource locators associated with a plurality of webpages; and
generate a priority list of the plurality of uniform resource locators, wherein the priority list is generated based on one of: frequency of each uniform resource locator in an advertisement stream, frequency of changes on the webpage associated with each uniform resource locator, page popularity of each uniform resource locator, and a utility estimate of each uniform resource locator.

29. A non-transitory computer-readable medium containing computer-executable instructions that, when executed by a processor, cause the processor to perform a method for rating webpages for safe advertising, the method comprising:
receiving a uniform resource locator corresponding to a webpage;
selecting a plurality of evidentiary sources for obtaining evidence relating to the uniform resource locator, wherein each piece of evidence corresponds to one of the plurality of evidentiary sources;
converting each piece of evidence obtained from the plurality of evidentiary sources into a plurality of instances that describe the webpage;
applying the plurality of instances to a plurality of rating models, wherein each of the plurality of rating models generates an ordinomial and wherein the ordinomial encodes a probability of membership in one or more severity classes of a category;
combining the ordinomial from each of the plurality of rating models into a combined ordinomial probability estimate; and
generating a rating for the webpage based at least in part on the combined ordinomial probability estimate, wherein the rating identifies whether the webpage is likely to contain objectionable content of the category.
